(19) United States
(12) Patent Application Publication
(10) Pub. No.: US 2020/0018911 A1
(43) Pub. Date: Jan. 16, 2020

(54) OPTICAL MODULE

(71) Applicant: FUJITSU COMPONENT LIMITED, Tokyo (JP)

(72) Inventor: Tatsuhiro Mori, Tokyo (JP)

(21) Appl. No.: 16/506,196

(22) Filed: Jul. 9, 2019

(30) Foreign Application Priority Data
Jul. 12, 2018 (JP) 2018-132555

(51) Int. Cl. G02B 6/42; G02B 6/32; F21V 8/00

(52) U.S. Cl. CPC G02B 6/4239; G02B 6/32; G02F 2202/28; G02B 6/4245; G02B 6/0053; G02B 6/4206

(57) ABSTRACT

An optical module includes a lens sheet having a plurality of lenses on an upper surface thereof, a substrate having at least one of a light emitting device and a light receiving device on an upper surface thereof, and an adhesive film bonding the upper surface of the lens sheet and a lower surface of the substrate, wherein the lens sheet has a plurality of protrusions on the upper surface thereof, and the substrate has through holes in which the protrusions are situated.

### BACKGROUND

### 1. Field

The disclosures herein relate to an optical module.

### 2. Description of the Related Art

A QSFP (Quad Small Form-factor Pluggable) optical module used for QSFP, which is an interface standard for optical communication, has an optical module in which light emitters and light receivers are mounted on optical waveguides. A flexible substrate and a lens sheet are bonded with adhesive sheets, and gaps between the components are filled with a resin or an adhesive to fix the surroundings of the adhesive sheets.

When mounting an optical module in an optical module, the optical waveguide may be stretched, or the flexible substrate may be subjected to stress, resulting in lenses of the lens sheet being shifted out of alignment with the light emitters/receivers. Such misalignment causes optical loss, which results in the degradation of optical module characteristics.

Accordingly, there may be a need for an optical module in which misalignment between the lens sheet and the substrate does not occur at the time of mounting the optical module. [Related-Art Documents]

### [Patent Document 1] Japanese Patent Application Publication No. 2017-125956

### [Patent Document 2] Japanese Patent Application Publication No. 2014-102399

### SUMMARY

According to an embodiment, an optical module includes a lens sheet having a plurality of lenses and protrusions on a first surface thereof, a substrate having at least one of a light emitter and a light receiver on a first surface thereof, and has through holes corresponds to one of the protrusions, respectively, and an adhesive film bonding the first surface of the lens sheet and a second surface of the substrate.

According to at least one embodiment, misalignment between a lens sheet and a substrate does not occur at the time of mounting an optical module.

### BRIEF DESCRIPTION OF THE DRAWINGS

FIG. 1 is an exploded view of an optical module;

FIGS. 2A and 2B illustrate a process of making the optical module;

FIGS. 3A and 3B illustrate a process of making the optical module;

FIGS. 4A and 4B illustrate a process of making the optical module;

FIGS. 5A and 5B illustrate a process of making the optical module;

FIGS. 6A and 6B illustrate a process of making the optical module;

FIG. 7 illustrates a process of making the optical module;

FIG. 8 illustrates another optical module;

FIG. 9 is a cross-sectional view of such another optical module;

FIG. 10 illustrates yet another optical module;

FIG. 11 is a cross-sectional view of the optical module;

FIG. 12 is an exploded view of the optical module of a first embodiment;

FIG. 13 illustrates a lens sheet according to the first embodiment;

FIG. 14 is illustrates a flexible substrate according to the first embodiment;

FIGS. 15A and 15B illustrate a process of making the optical module of the first embodiment;

FIGS. 16A and 16B illustrate a process of making the optical module;

FIGS. 17A and 17B illustrate a process of making the optical module;

FIGS. 18A and 18B illustrate a process of making the optical module;

FIGS. 19A and 19B illustrate a process of making the optical module;

FIGS. 20A and 20B illustrate a process of making the optical module;

FIG. 21 illustrates a first variation of the optical module of the first embodiment;

FIG. 22 illustrates a second variation of the optical module of the first embodiment;

FIG. 23 is a top view of an optical module of a second embodiment; and

FIG. 24 is a cross-sectional view of the optical module of the second embodiment.

### DESCRIPTION OF EMBODIMENTS

In the following, embodiments for implementing the invention will be described. The same members are referred to by the same numerals, and a description thereof will be omitted.

### First Embodiment

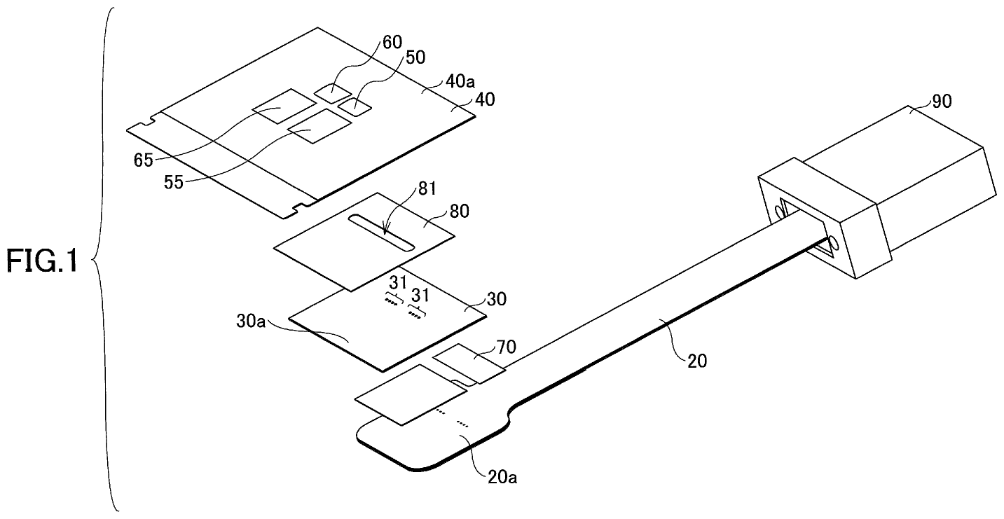

FIG. 1 is an exploded view of an optical module. An optical module illustrated in FIG. 1 is configured such that a lens sheet 30 and a flexible substrate 40 are stacked one over another on an optical waveguide 20.

A ferrule 90 having a lens is attached to the optical waveguide 20. Lenses 31 are formed on the lens sheet 30. The optical waveguide 20 and the lens sheet 30 are bonded together through adhesive sheets 70.

A light emitter 50, a light receiver 60, a driver 55, and a TIA (trans-impedance amplifier) 65 are mounted on the substrate 40.

A through hole is formed in the substrate 40 at the position of an optical path to pass light. The substrate 40 and the lens sheet 30 are bonded together through an adhesive sheet 80. A through hole 81 is formed in the adhesive sheet 80 at the position of the optical path. In the present application, the adhesive sheet 80 may sometimes be referred to as an adhesive film.

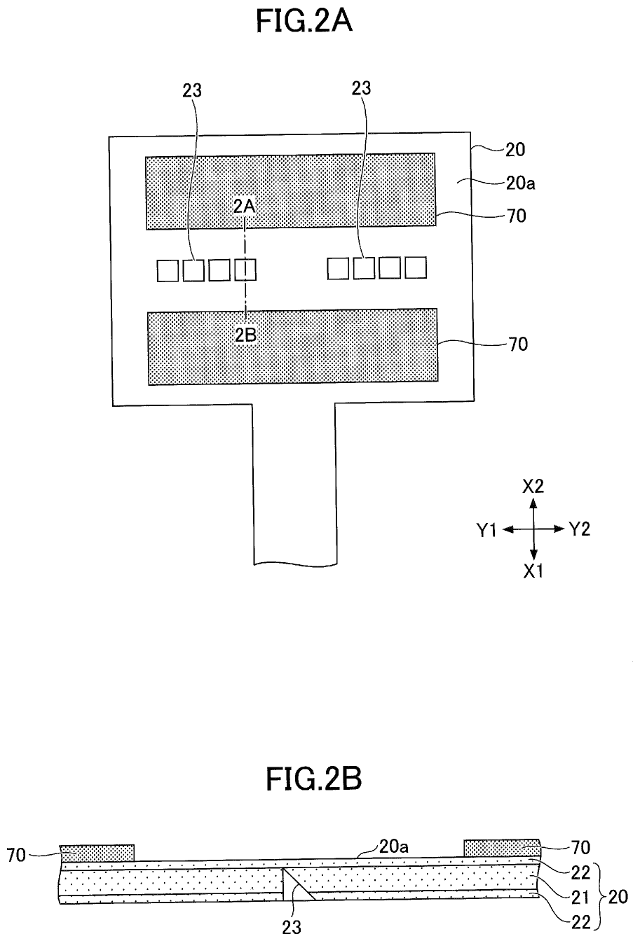

The process of making an optical module will be described with reference to FIGS. 2A and 2B through FIG. 7. For the sake of convenience, sizes and dimensions illustrated in FIGS. 2 to 7 may differ from real sizes and dimensions, and the positions of lenses 31 may be different from those illustrated in FIG. 1.

FIG. 2A is a top view of the optical waveguide 20. FIG. 2B is a cross-sectional view taken along a line 2A-23 in FIG. 2A. The adhesive sheets 70 are attached to the surface 20a. The optical waveguide 20 has a cladding 22 covering a core 21 through which light propagates. A portion of the core 21 is removed from the optical waveguide 20 to form a mirror 23. The adhesive sheets 70 are not attached to a portion of the optical waveguide 20 covering the the mirror 23, to avoid bubbles trapped between the optical waveguide 20 and the adhesive sheets 70 may be present on the optical path to scatter light and to cause optical loss.

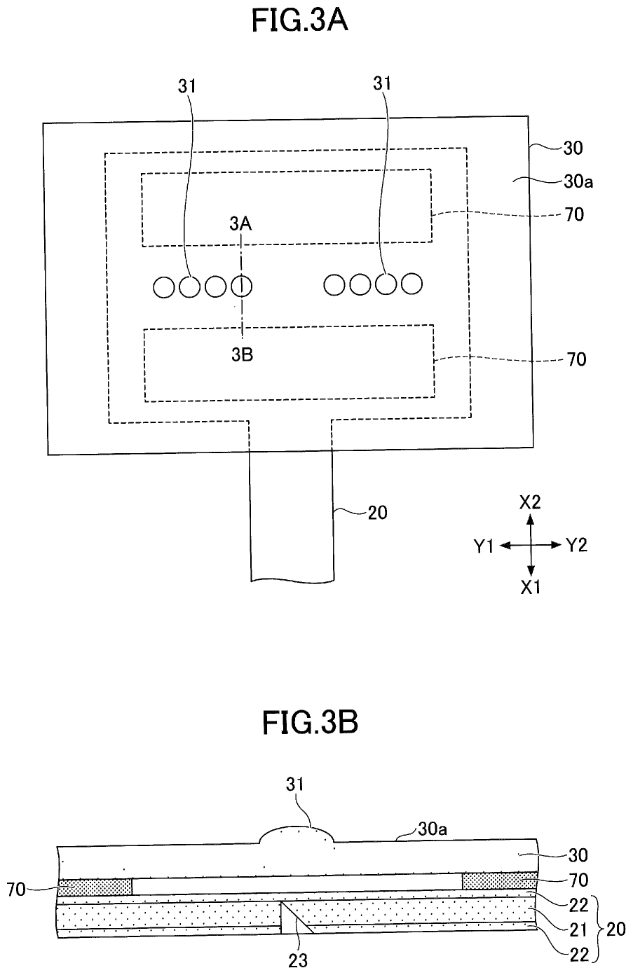

FIG. 3A is a top view of the optical waveguide 20. FIG. 3B is a cross-sectional view taken along a line 3A-3B in FIG. 3A. The lens sheet 30 is attached to the adhesive sheets 70, and the lenses 31 are aligned with the mirrors 23.

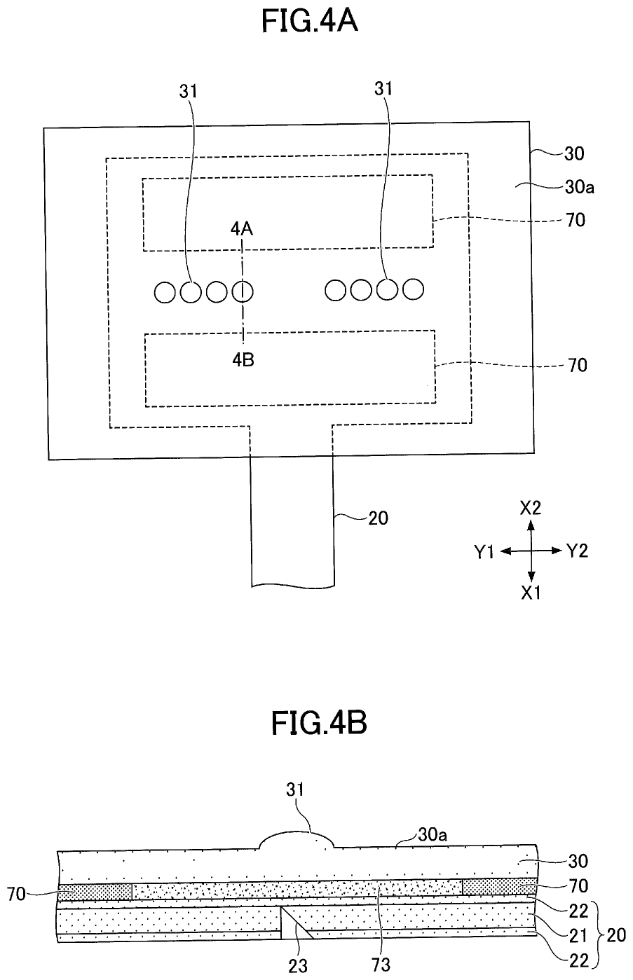

FIG. 4A is a top view of the optical waveguide 20. FIG. 4B is a cross-sectional view taken along a line 4A-4B in FIG. 4A. The optical waveguide 20 and the lens sheet 30 are bonded with an ultraviolet curing adhesive 73 provided therebetween. Ultraviolet light is incident on the surface 30a to cure the adhesive 73. The uncured adhesive 73 enters and fills a space between the lens sheet 30 and the optical waveguide 20. The cured adhesive 73 has a refractive index substantially identical to the refractive index of the lens sheet 30, so that there is no optical loss in the optical path. An ultraviolet curing adhesive may be referred to as an ultraviolet curable resin.

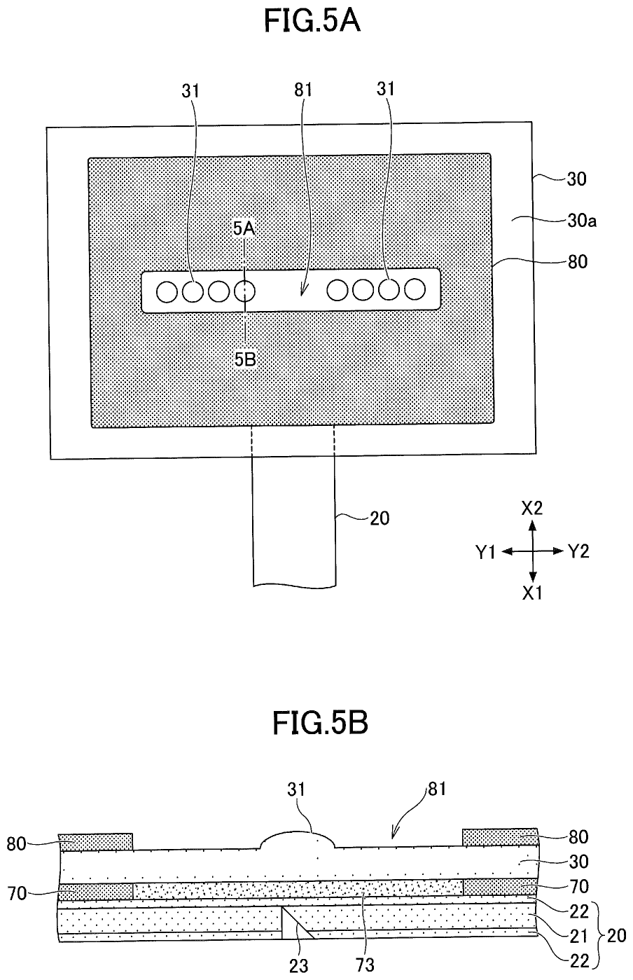

FIG. 5A is a top view of the optical waveguide 20. FIG. 5B is a cross-sectional view taken along a line 5A-5B in FIG. 5A. The adhesive sheet 80 provided with the through hole 81 is attached to the surface 30a and is aligned with the lens sheet 30 such that the lenses 31 are situated in the through holes 81.

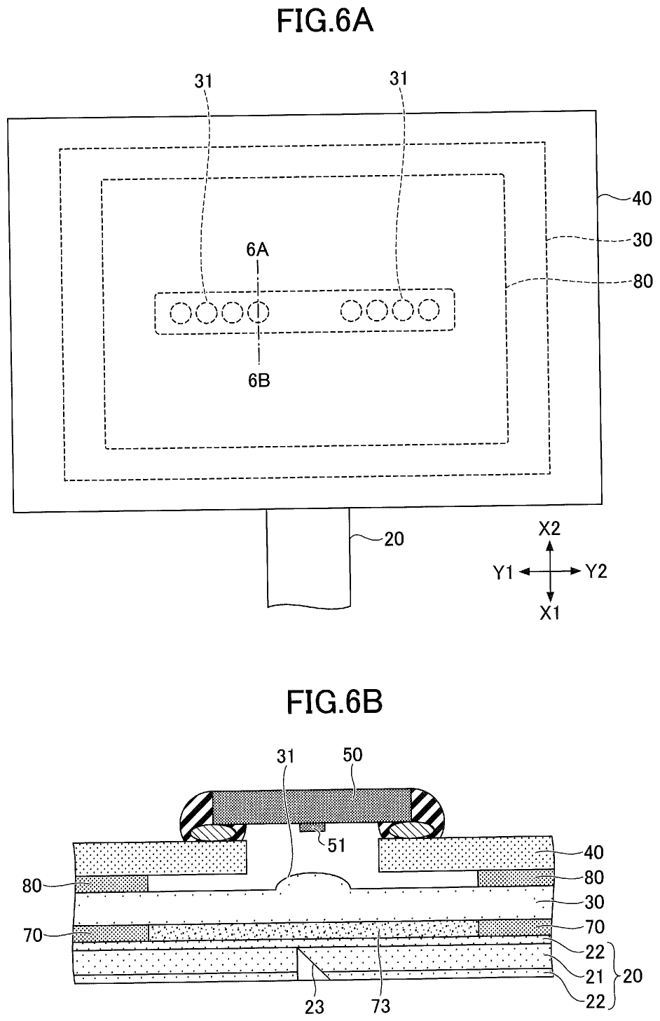

FIG. 6A is a top view of the optical waveguide 20. FIG. 6B is a cross-sectional view taken along a line 6A-6B in FIG. 6A. The substrate 40 is attached to the adhesive sheet 80. In FIG. 6A, the light emitter 50, the light receiver 60, the driver 55 and the TIA 65 mounted on the substrate 40 are omitted. The light emitting sections 51 of the light emitter 50 and the light receiving sections of the light receiver 60 are aligned with the lenses 31 when the substrate 40 is attached to the adhesive sheet 80.

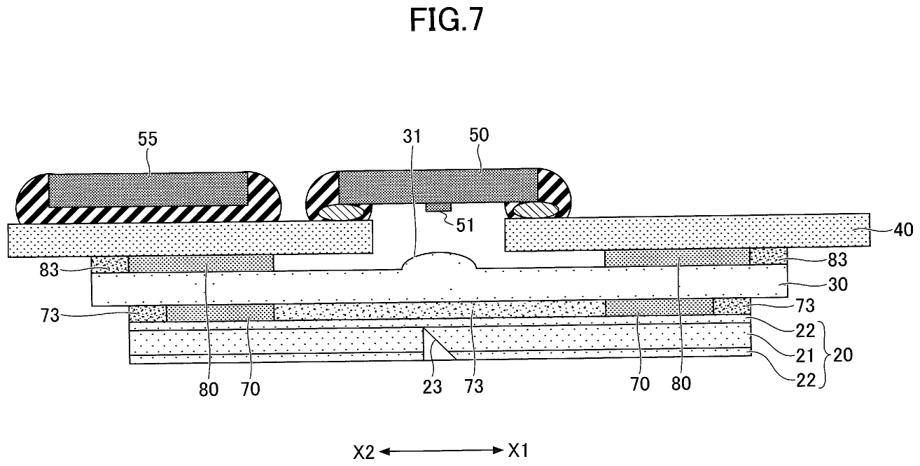

As illustrated in FIG. 7, an ultraviolet curing adhesive 83 is used for bonding the lens sheet 30 and the substrate 40. The adhesive 83 between the lens sheet 30 and the substrate 40 is cured with ultraviolet light incident from the side where the optical waveguide 20 is situated. The adhesive 83 does not enter the space between the portion of the lens sheet 30 having the lenses 31 and the light emitter 50 or the light receiver 60.

When the optical module is mounted in the housing, a stretching force may be applied to the optical waveguide 20. As the optical waveguide 20 extends lengthwise in the X1-X2 direction and is connected to the ferrule 90, the optical waveguide 20 may be pulled in the X1 direction when connecting the optical waveguide 20 with the ferrule 90.

As illustrated in FIG. 7, the adhesive sheet 80 extends over a bonding area between the lens sheet 30 and the substrate 40. When the optical waveguide 20 is pulled, the adhesive sheet 80 deforms and the lens sheet 30 being displaced in the X1 direction relative to the light emitter 50.

Such a misalignment between the lenses 31 and light emitting sections 51 causes light incident on the mirrors 23 to decrease relative to the amount of light emitted by the light emitter 50.

Similarly, a misalignment between the lenses 31 and the light receiving sections causes light incident on the light receivers through the lenses 31 to decrease relative to the amount of light reflected by the mirrors 23, and increasing the optical loss.

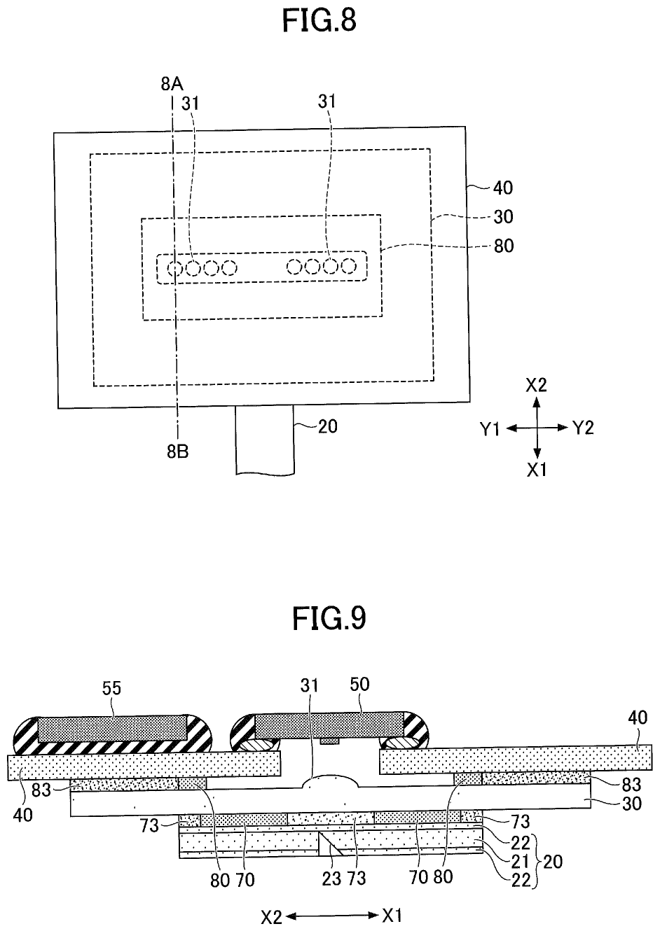

FIG. 8 is a top view of an optical module. FIG. 9 is a cross-sectional view taken along a 8A-8B in FIG. 8. To prevent an increase in optical loss in an optical module, the end of the optical waveguide 20 and the adhesive sheets 70 and 80 may be reduced in size as illustrated in FIGS. 8 and 9 to increase the adhesion area covered by the adhesive 83 between the lens sheet 30 and the substrate 40. Since the cured adhesive 83 is not easily deformed, it is possible to prevent a misalignment between the lens sheet 30 and the substrate 40. However, this arrangement also results in an adhesion area between the optical waveguide 20 and the lens sheet 30 being reduced, so that misalignment between the optical waveguide 20 and the lens sheet 30 may occur. Further, the optical waveguide 20 and the adhesive sheets 70 and 80 are difficult to manufacture if reduced in size.

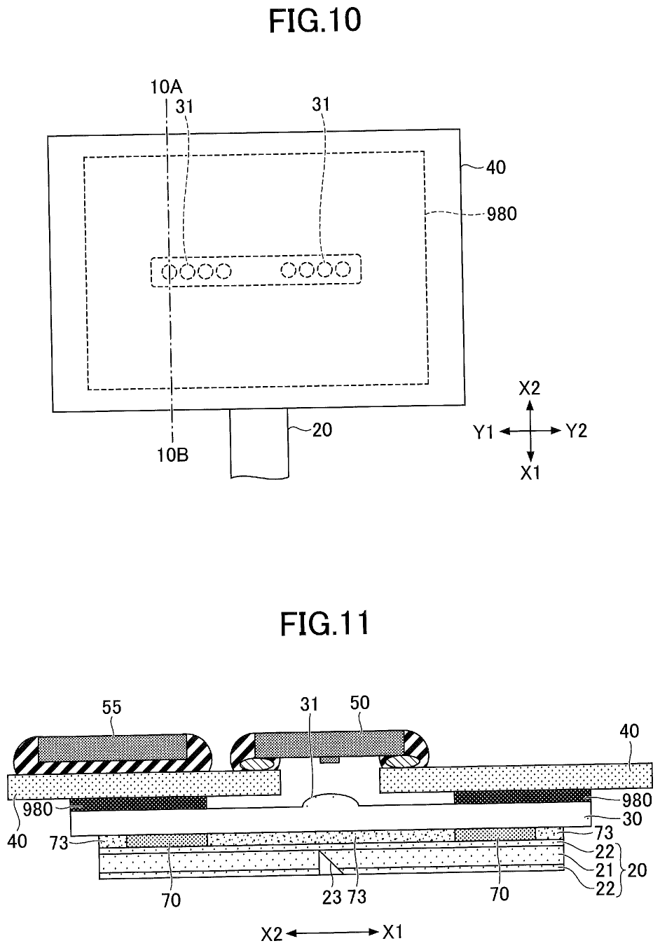

FIG. 10 is a top view of an optical module. FIG. 11 is a cross-sectional view taken along a line 10A-10B in FIG. 10. As another arrangement, the lens sheet 30 and the substrate 40 may be bonded through a thermosetting adhesive sheet 980. This arrangement can prevent a misalignment between the lens sheet 30 and the substrate 40. However, the use of the adhesive sheet 980 requires heating and pressurizing during adhesion. Moreover, the curing of the adhesive sheet 980 requires heating to 100 degrees Celsius or more, which may cause physical damage to the optical waveguide 20 and the lens sheet 30 made of resin. Since it is necessary to maintain the heated and pressurized condition for a predetermined time, the manufacturing process becomes lengthy.

### <Optical Module>

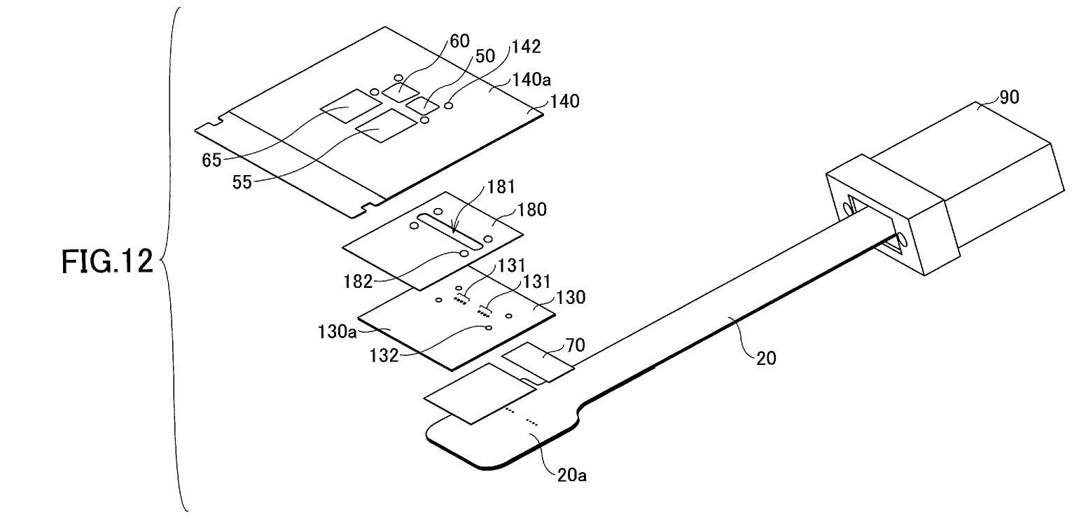

An optical module of the first embodiment will be described. FIG. 12 is an exploded view of an optical module of the present embodiment. The optical module is configured such that a lens sheet 130 and a substrate 140 are stacked one over another on a sheet-shaped optical waveguide 20.

A ferrule 90 having a lens is attached to the optical waveguide 20. Lenses 131 are formed on the lens sheet 130. A surface 20a of the optical waveguide 20 and the lens sheet 130 are bonded together through adhesive sheets 70.

A light emitter 50, a light receiver 60, a driver 55, and a TIA 65 are mounted on the substrate 140. A through hole (not shown) is formed in the substrate 140 at the position of an optical path to pass light emitted by the light emitter 50 and light entering the light receiver 60. The substrate 140 and the lens sheet 130 are bonded together through an adhesive sheet 180. A through hole 181 is formed in the adhesive sheet 180 at the position of the optical path.

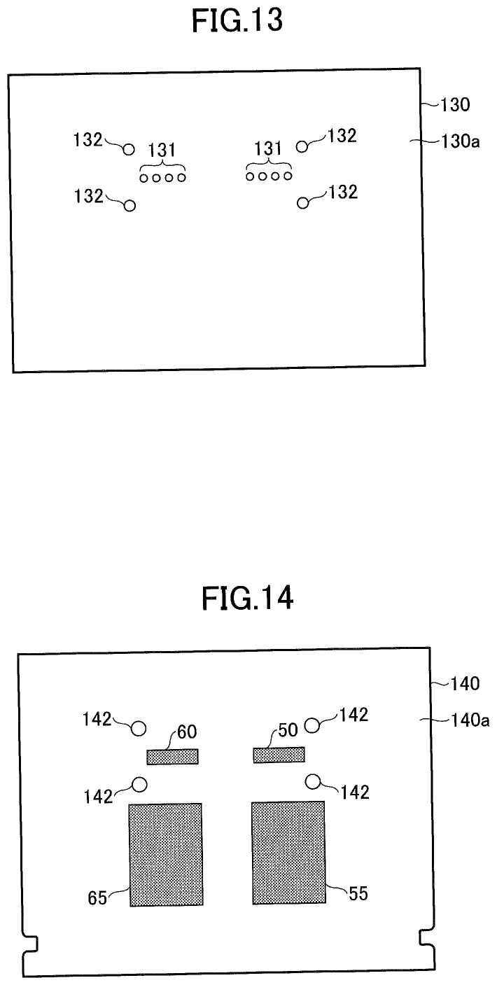

Protrusions 132 are provided on the lens sheet 130 at four points around the lenses 131 as illustrated in FIG. 13. As illustrated in FIG. 14, the substrate 140 has four through holes 142 and the adhesive sheet 180 has four through holes 182 formed at positions corresponding to protrusions 132.

### <Process of Making Optical Module>

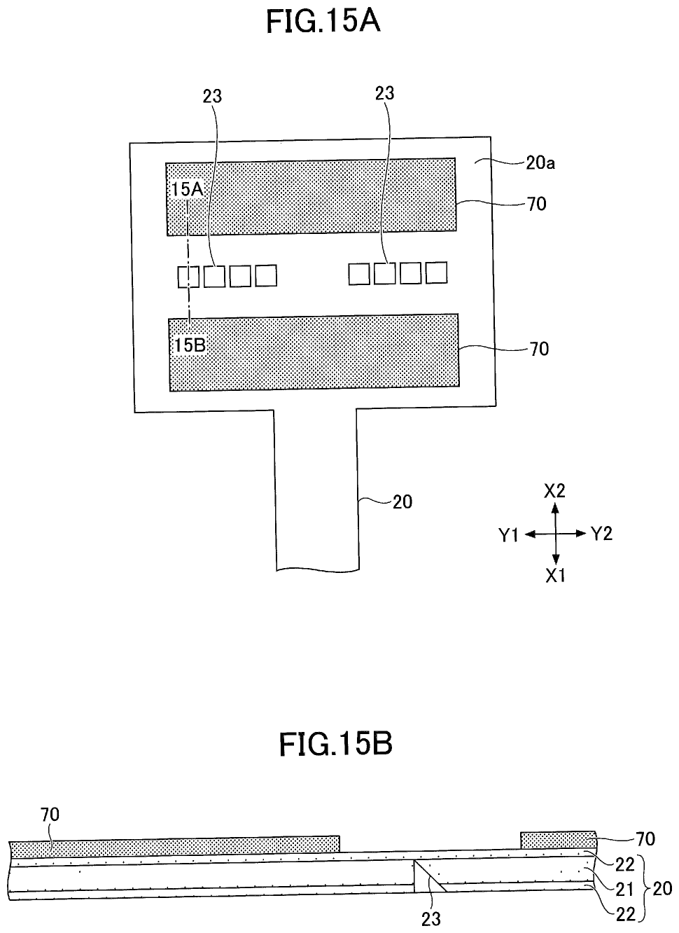

The process of making the optical module will be described with reference to FIGS. 15A and 15B through FIGS. 20A and 20B. For the sake of convenience, the positions of the lenses 131, the protrusions 132 and the through holes 142 illustrated in FIGS. 15A and 15B through FIGS. 20A and 20B are different from those illustrated in FIGS. 12 through 14.

FIG. 15A is a top view of the optical waveguide 20. FIG. 15B is a cross-sectional view taken along a line 15A-15B in FIG. 15A. The adhesive sheets 70 are attached to the surface 20a at predetermined positions as illustrated in FIGS. 15A and 15B.

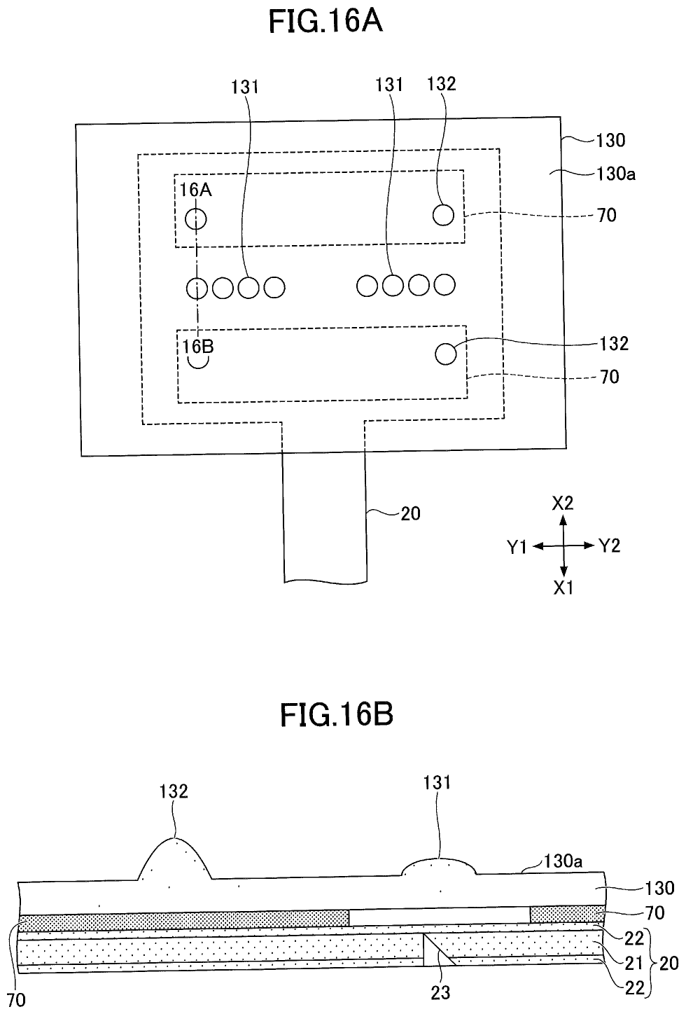

FIG. 16A is a top view of the optical waveguide 20. FIG. 16B is a cross-sectional view taken along a line 16A-16B in FIG. 16A. The lenses 131 are aligned with the corresponding mirrors 23 when the lens sheet 130 is attached to the adhesive sheets 70. Heights of the protrusions 132 are slightly higher than the height of the lenses 131.

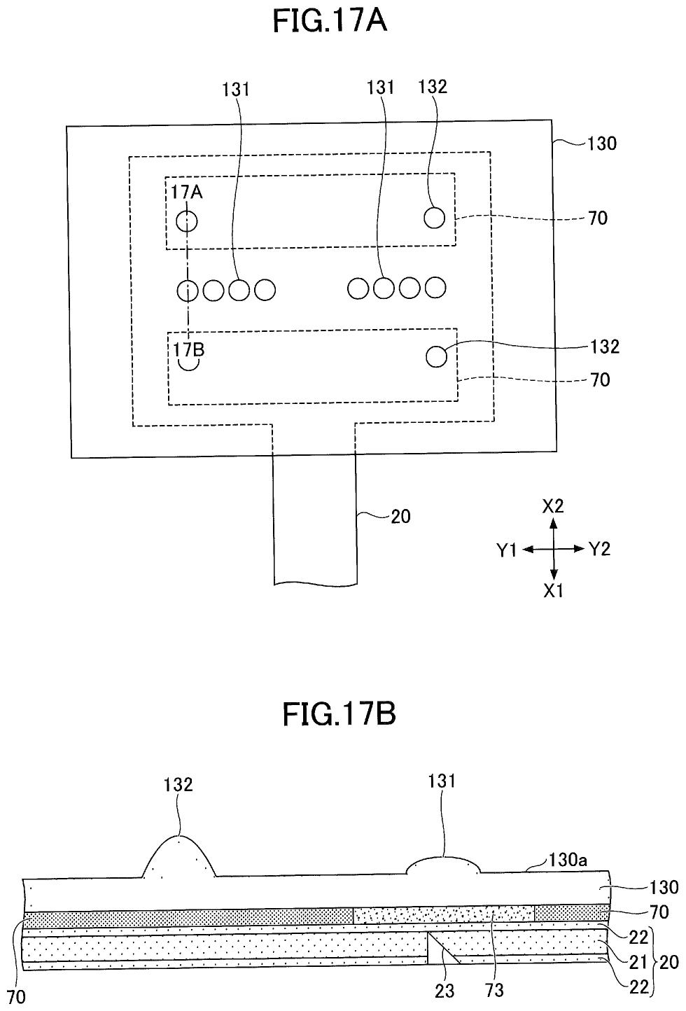

FIG. 17A is a top view of the optical waveguide 20. FIG. 17B is a cross-sectional view taken along a line 17A-17B in FIG. 17A. The optical waveguide 20 and the lens sheet 130 are bonded to each other with an ultraviolet curing adhesive 73 provided therebetween. The adhesive 73 is cured with ultraviolet light incidents on the lens sheet 130.

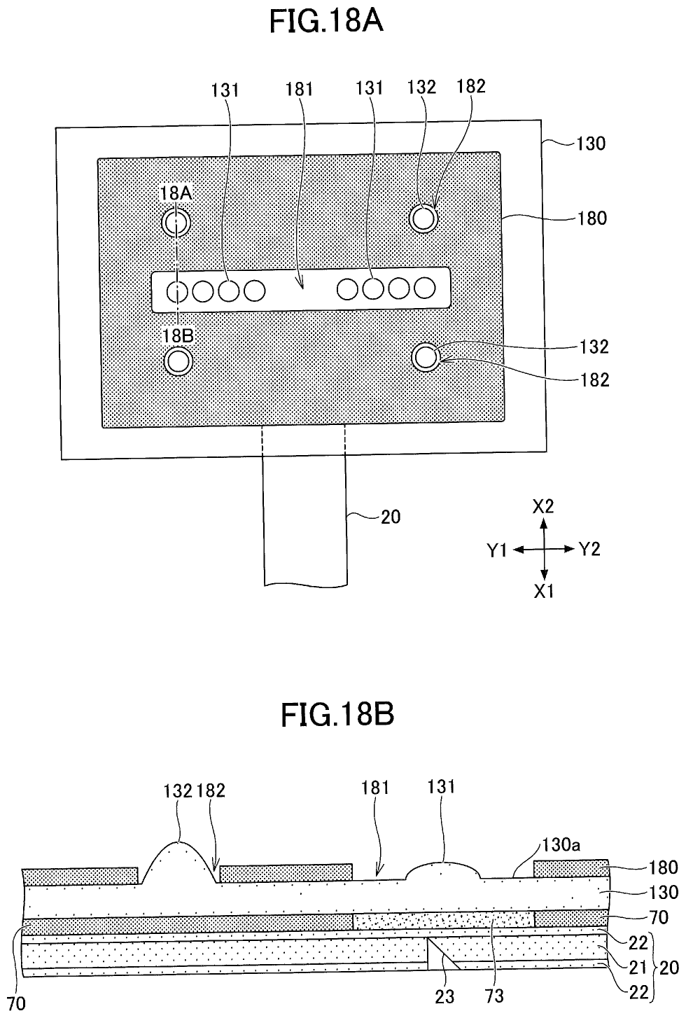

FIG. 18A is a top view of the optical waveguide 20. FIG. 18B is a cross-sectional view taken along a line 18A-18B in FIG. 18A. The adhesive sheet 180 provided with through holes 181 and 182 is attached to the lens sheet 130. An alignment is made such that the lenses 131 are situated in the through holes 181 and the protrusions 132 are situated in the through holes 182 when the adhesive sheet 180 is attached to the lens sheet 130.

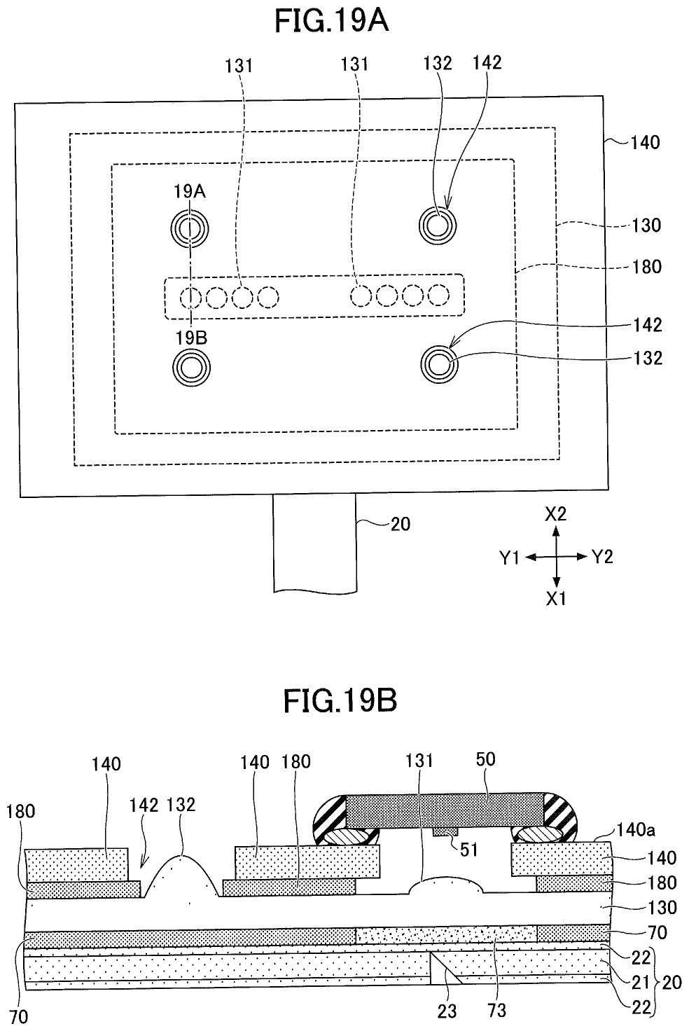

FIG. 19A is a top view of the optical waveguide 20. FIG. 19B is a cross-sectional view taken along a line 19A-19B in FIG. 19A. The substrate 140 is attached to the adhesive sheet 180. In FIG. 19A, the light emitter 50, the light receiver 60, the driver 55 and the TIA 65 are omitted. The light emitting sections 51 and the light receiving sections of the light receiver 60 are aligned with the lenses 131. The substrate 140 is attached to the adhesive sheet 180 such that the protrusions 132 are inserted into the through holes 142. The height of the projections 132 is preferably lower than the surface 140a of the substrate 140.

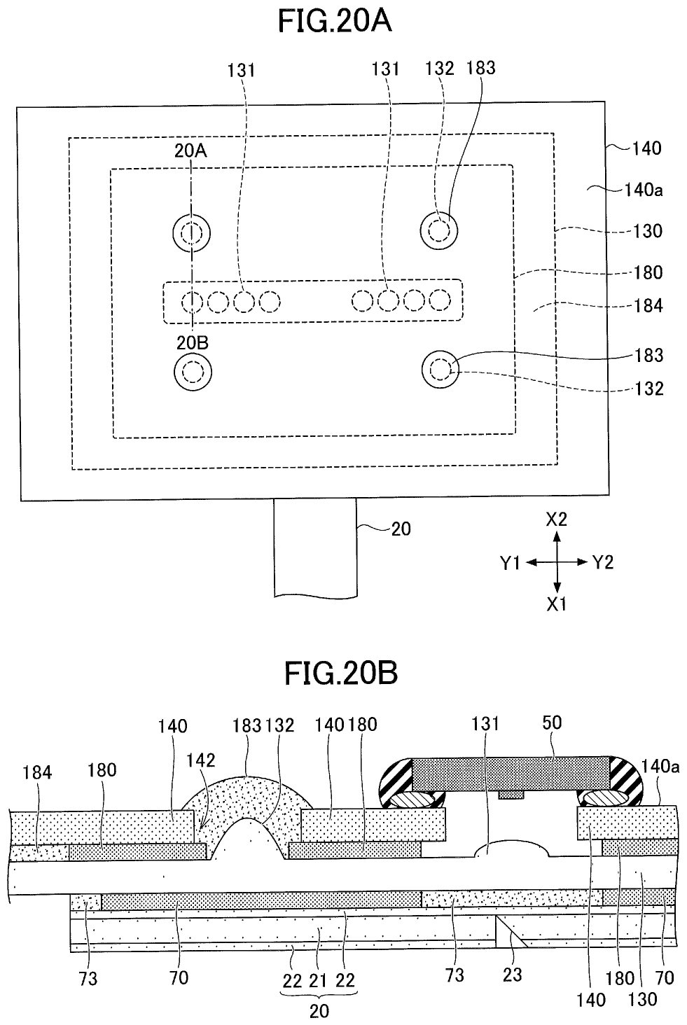

FIG. 20A is a top view of the optical waveguide 20. FIG. 20B is a cross-sectional view taken along a line 20A-20B in FIG. 20A. The lens sheet 130 and the substrate 140 are bonded with an ultraviolet curing adhesive 184 provided therebetween, and an ultraviolet curing adhesive 183 is dropped into the through holes 142 to fill the gap between the through hole 142 and the protrusion 132. Then the adhesive 183 is cured.

The present embodiment prevents the lens sheet 130 from moving relative to the substrate 140, and allowing the optical module to be manufactured at a high yield. A cold setting resin that cures at room temperature may be used in place of the adhesive 183.

<Variation>

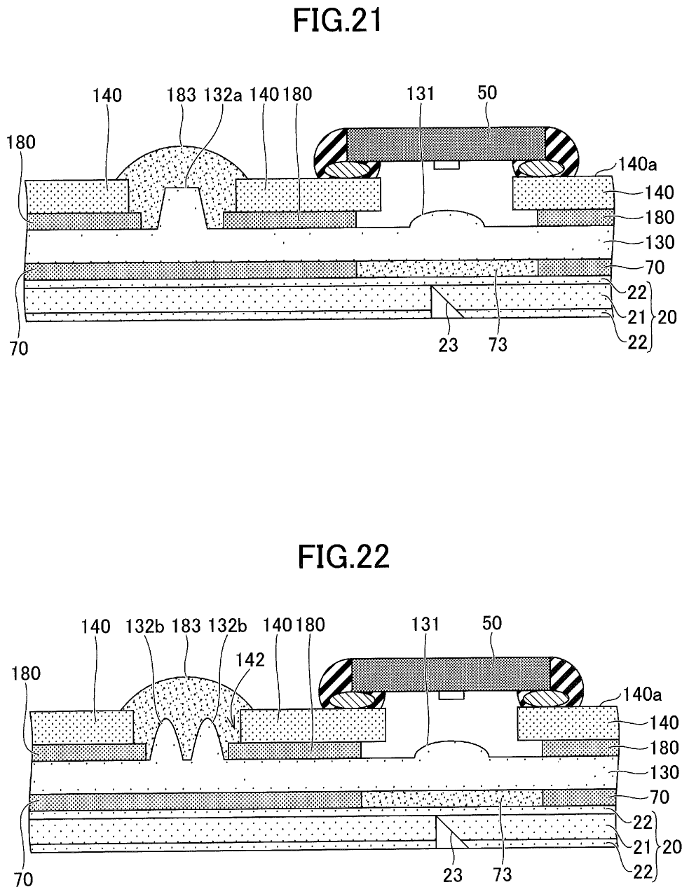

An optical module according to a variation may have a rectangular or trapezoid protrusions 132a formed on the lens sheet 130 as illustrated in FIG. 21. Protrusions 132b on the lens sheet 130 may fit into a single through hole 142 as illustrated in FIG. 22.

### Second Embodiment

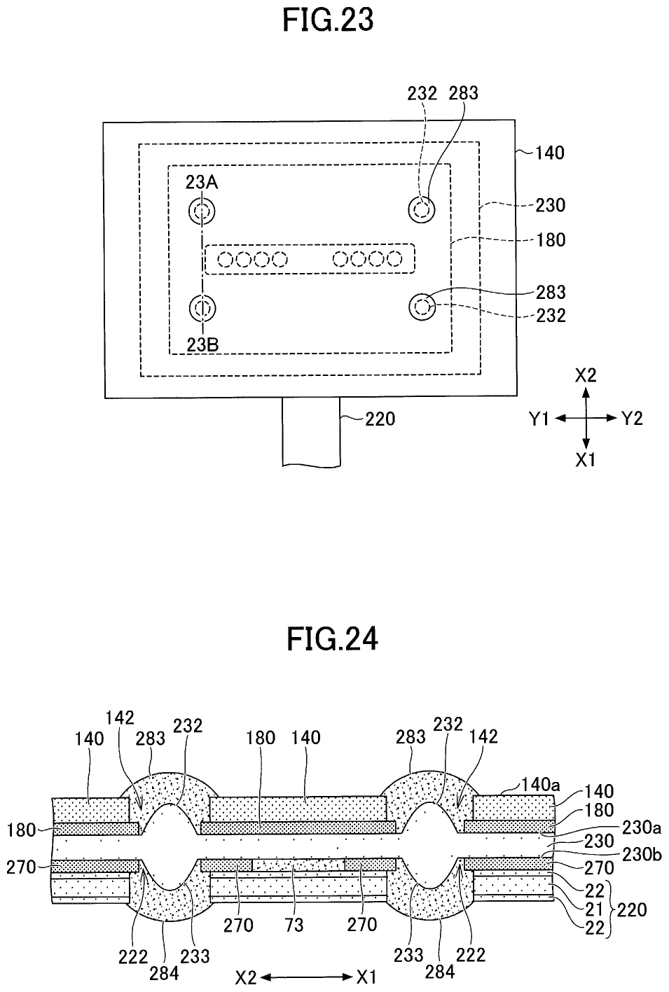

An optical module according to a second embodiment is configured such that first protrusions 232 are provided on a front surface 230a of a lens sheet 230 and second protrusions 233 are provided on a back surface 230b, as illustrated in FIGS. 23 and 24. Through holes 222 corresponding to the second projections 233 are formed in an optical waveguide 220. Corresponding through holes are formed in an adhesive sheet 270. Similarly to the first embodiment, through holes 142 corresponding to the first protrusions 232 are formed in the substrate 140, and corresponding through holes are formed in the adhesive sheet 180.

The first protrusions 232 situated in the through holes 142 are securely held by a cured adhesive 283. The second protrusions 233 in the through holes 222 are securely held by a cured adhesive 284.

The optical module according to the present embodiment not only prevents misalignment between the lens sheet 230 and the substrate 140, but also prevents misalignment between the lens sheet 230 and the optical waveguide 220.

Other aspects than those described above are the same as or similar to those of the first embodiment.

Although a description has been given with respect to one or more embodiments, the contents of the description do not limit the scope of the invention.

The present application is based on and claims priority to Japanese patent application No. 2018-132555 filed on Jul. 12, 2018, with the Japanese Patent Office, the entire contents of which are hereby incorporated by reference.

What is claimed is:

1. An optical module, comprising:
a lens sheet having a plurality of lenses and protrusions on a first surface thereof;
a substrate having at least one of a light emitter and a light receiver on a first surface thereof, and has through holes corresponds to one of the protrusions, respectively; and
an adhesive film bonding the first surface of the lens sheet and a second surface of the substrate.

2. The optical module as claimed in claim 1, wherein the protrusions are immovably held in the through holes by a hardened resin material.

3. The optical module as claimed in claim 1, further comprising:
an optical waveguide; and
a second adhesive film bonding a second surface of the lens sheet and the optical waveguide,
wherein the lens sheet has additional protrusions on the second surface thereof, and the optical waveguide has second through holes in which the additional protrusions are situated.

4. The optical module as claimed in claim 3, wherein the additional protrusions are immovably held in the second through holes by a hardened resin material.
